(19) United States
(12) Patent Application Publication
(10) Pub. No.: US 2010/0270435 A1
(43) Pub. Date: Oct. 28, 2010

(54) Wing efficiency for tilt-rotor aircraft

(76) Inventor: Abe Karem, Tustin, CA (US)

Correspondence Address: FISH & ASSOCIATES, PC;ROBERT D. FISH, 2603 Main Street, Suite 1000, Irvine, CA, 92614-6232, US

(21) Appl. No.: 11/505,067

(22) Filed: Aug. 15, 2006

Related U.S. Application Data
(60) Provisional application No. 60/708,805, filed on Aug. 15, 2005.

(51) Int. Cl. B64C 27/22

(52) U.S. Cl. 244/7 R

(57) ABSTRACT

Rotorcraft wings disposed between tilt-rotor nacelles have particularly high aspect ratios for tilt-rotor rotorcraft, including for example at least 6, 7, 8, or higher. The increase in wing span and aspect ratio is possible because of the use of rigid and semi-rigid rotors, and/or higher modulus of elasticity materials allows increases the stiffness of the wings to the level required for avoiding whirl flutter. Tilt-rotor aircraft having high aspect ratio wings can advantageously further include a controller that provides reduced RPM in a forward flight relative to hover, and/or a controller that provides variable speed, (a so-called “Optimum Speed Tilt Rotor”) as set forth in U.S. Pat. No. 6,641,365 to Karem (November 2003).

This application claims priority to U.S. Provisional Application Ser No. 60/708805 filed Aug. 15, 2005.

### FIELD OF THE INVENTION

The field of the invention is tilt-rotor aircraft.

### BACKGROUND OF THE INVENTION

The cruise efficiency of aircraft as measured by its payload carried times the distance traveled per consumed fuel (for example Lb of Payload×Mile traveled/Lb of consumed fuel) is proportional to the ratio between lift and drag of the aircraft in cruise flight.

The best (highest) lift/drag ratio of a fixed wing aircraft is strongly related to the ratio of wing span to the size of the aircraft. For example, competition gliders use very small and streamlined fuselage (for low drag) and large span wings for best lift/drag (glide ratio).

The flight speed for best lift/drag ratio, at given aircraft weight and altitude is a function of wing area. An aircraft with smaller wing area will have higher speed for best lift/drag. The ratio of wing span squared to wing area (same as the ratio of span to average wing chord) is called the wing aspect ratio. The combination of increasing glide ratio (larger span) and decreasing wing area (increasing speed) result in a strong drive to increase the wing aspect ratio (long and narrow wings). High wing aspect ratios are limited by structures, weight and structural dynamics considerations.

While high performance gliders use wing aspect ratio ranging from 20 to 38, the values for modern swept back wings of jet transports are 8-10 and for straight wings of propeller driven transports are 10-12. The use of high strength/weight carbon fiber composites makes higher aspect ratio wings more efficient in terms of aerodynamic performance vs. wing weight.

Tilt-rotor aircraft are aircraft that use the lift of rotors to hover and perform Vertical Take-Off and Landing (VTOL). These aircraft tilt their rotors so that in forward flight the lift is provided by the wing, and forward thrust by the rotors. The successful development of tilt-rotor aircraft in the last 30 years (Bell XV-15, Bell/Boeing V-22 and Bell/Agusta 609) make the tilt-rotor configuration a commercially viable starting point for efficient VTOL aircraft.

Prior art tilt-rotor aircraft have wing aspect ratios of 5.5, with the tilt-rotors, engines and nacelles placed essentially at the wing tips. A particularly important consideration for such a low aspect ratio is the desire to deploy a very stiff wing to avoid whirl flutter, which is an aero-elastic instability of the combination of wing and rotor. The wider chord wing of 5.5 aspect ratio causes a high down-load in hover of 11-12% of rotor lift, therefore requires larger rotors, more powerful engines and higher torque gearboxes to overcome this increase in required rotor lift.

All current tilt-rotor aircraft have adopted the same sense of rotor rotation, top blade turning outward. This sense of rotation provides an interaction between the rotor and wing that is functionally equivalent to approximately 10% increase in wing aspect ratio. Nevertheless, the very low aspect ratios of prior art tilt-rotor aircraft results in considerable inefficiencies. Thus, there is still a need to provide tilt-rotor aircraft with higher wing aspect ratios, in a manner that provides increased aircraft efficiency and fuel economy

### SUMMARY OF THE INVENTION

The present invention provides apparatus and methods in which rotorcraft wings disposed between tilt-rotor nacelles have particularly high aspect ratios for tilt-rotor rotorcraft, including for example at least 6, 7, 8, or higher.

Such higher aspect ratio wings are particularly contemplated for one or more of tilt-rotor aircraft equipped with rigid or semi-rigid rotors; where the rotors are not teetering, gimbaled, or articulated. The rotors are also preferably low inertia rotors with high stiffness blades. As used herein, the term “low inertia rotor” means a rotor having a blade with a weight in lbs. that does not exceed the product of 0.004 times the diameter of the rotor in feet cubed, and the term “high stiffness blade” means a blade having a flap stiffness in lbs-in² at R30 that is at least equal to the product of 100 times the rotor diameter in feet to the fourth power. The notation “Rxx” means a station on the blade at a distance from a center of rotor rotation that is xx% of the rotor radius, so that R30 means a distance from a center of rotor rotation that is 30% of the rotor radius.

The most successful tilt-rotor rotorcrafts of the last 30 years (Bell XV-15, Bell/Boeing V-22 and Bell/Agusta BA609) use gimbaled rotors, which result in a substantial challenge of dynamic aero-structure instability called whirl flutter. Whirl flutter is an aero structural dynamic instability of the combination of the rotor and the wing. To avoid whirl flutter throughout the flight operation range, the prior art tilt-rotor rotorcrafts require high wing stiffness. By using rigid or semi-rigid rotors, especially ones with low inertia (lightweight blades), whirl flutter is substantially delayed to higher flying speeds and, as a result, longer and less rigid wing can be used with the inventive subject matter without excessive increase in wing weight.

The increase in wing span and aspect ratio is possible because of the use of rigid and semi-rigid rotors, which have less severe whirl flutter problems and therefore don't require the stiffness of the aspect ratio 5.5 wing. Alternatively, use of higher modulus of elasticity materials (for example higher modulus carbon fiber composites or other composite structural materials having elasticity modulus of at least 40 msi) allows the increase of wing aspect ratio by increasing the stiffness of such wing to the level required for avoiding whirl flutter with the current articulated rotors. Such composites were successfully used in aerospace applications including the rotor blades of the Boeing Hummingbird A160 unmanned helicopter. Still further, the combination of both rigid or semi-rigid rotors and higher modulus wing material allows for a higher level of improvement in wing span, cruise efficiency and hover efficiency.

In another aspect of the invention, tilt-rotor aircraft having high aspect ratio wings can advantageously further include a controller that provides reduced RPM in a forward flight relative to hover. In yet another aspect of the invention, tilt-rotor aircraft having high aspect ratio wings can have a controller that provides variable speed, (a so-called “Optimum Speed Tilt Rotor”) as set forth in U.S. Pat. No. 6,641,365 to Karem (Nov. 2003). The disclosure of this, and any other extraneous materials referenced herein, is/are incorporated by reference.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a prior art plan view of a modern twin tilt-rotor rotorcraft (Bell/Agusta BA 609).

FIG. 2 is a plan view of a modern twin tilt-rotor rotorcraft (Bell/Agusta BA 609), modified in accordance with aspects of the inventive subject matter.

### DETAILED DESCRIPTION

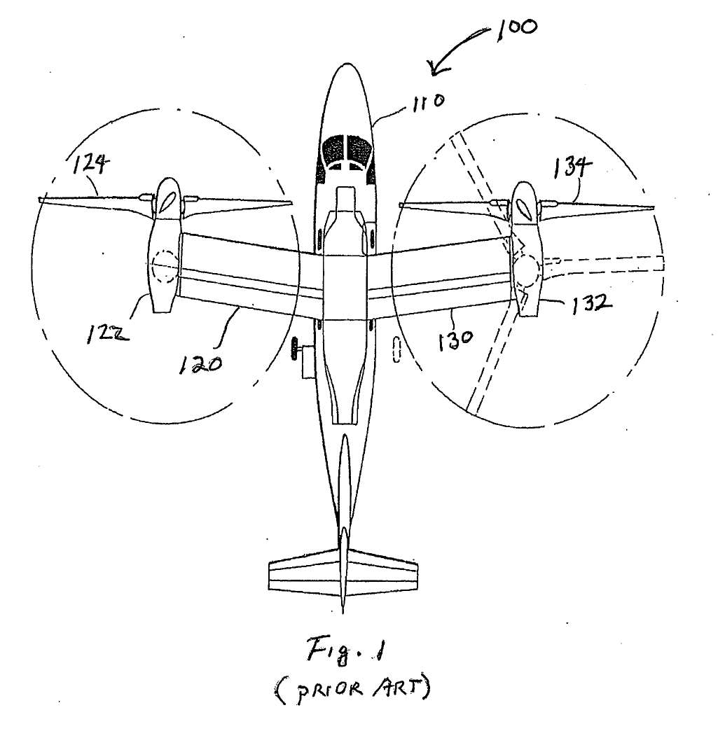

In FIG. 1 a rotorcraft 100 generally includes a fuselage 110, a left wing 120 with tilting nacelle 122 and rotor 124, and a right wing 130 with tilting nacelle 132 and rotor 134. As with other prior art aircraft of this type, the complete wing (120 plus 130 plus the center section attached to the fuselage) has a wing aspect ratio is 5.5. To illustrate the tilt-rotor aspect of the design in a simplified manner, the nacelles 122, 132, and the right rotor 134 are shown in the lifting configuration in dashed lines.

It should be appreciated that although rotorcraft 100 is depicted here in a substantially to-scale model of a Bell/Agusta BA 609, the drawing should be interpreted as being representative of tilt-rotorcraft in general. In particular, it is contemplated that the inventive subject matter could also be applied to quad tilt-rotor configuration, etc.

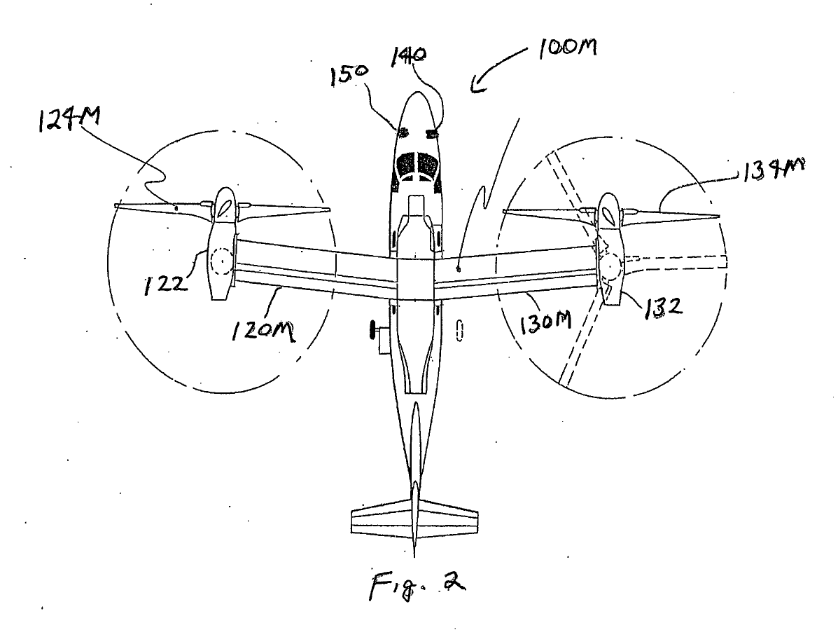

In FIG. 2 the rotorcraft 100M of FIG. 1 has been modified to have a wing aspect ratio of 9.3, which is a 69% increase from 5.5. To reflect differences from FIG. 1, the wings 120M, 130M of FIG. 2, and the rotors 124M, 134M are given the “M” designation to show that they are “modified” as discussed herein.

In this particular embodiment the increased wing aspect ratio has been achieved by increasing the wing span by 30% and decreasing the wing chord by 23%. In view of the teachings herein, it should be apparent to those skilled in the art that the same increase in wing aspect ratio could have been achieved using other combinations of altered wing span and/or altered wing chord. In addition, it should be apparent to those skilled in the art in view of the teachings herein that other increases in wing span could alternatively be implemented, including for example increases in wing aspect ratio of between 6 and 7, between 7 and 8, between 8 and 9, and between 9 and 10. Viewed from another perspective, the wing aspect ratio could be increased above 6, 7, 8, 9 or even 10 by increasing the wing span by at least 20%, at least 30%, or at least 40% relative to the standard design, with or without other changes. Similarly, it can be appreciated that the wing aspect ratio could be increased above 6, 7, 8 or even 9 by decreasing the wing chord by at least 10%, at least 15%, or at least 20% relative to the standard design, with or without other changes.

Another interesting feature of FIG. 2 is that the wing aspect ratio of 9.3 was achieved while maintaining the same wing area, and same wing airfoils and flap configuration. By maintaining the same wing area, airfoil, and flap configuration, the wing lift during maneuver from airplane mode to helicopter mode is maintained, and this critical maneuver stays the same as in the basic rotorcraft standard design. That achievement, however, is not absolutely critical, and it is contemplated that the wing aspect ratio could be increased above 6, 7, 8, 9 or even 10 while concomitantly modifying one or more of the wing area, airfoil, and flap configuration. As used herein, the term “flap” includes flaperons.

In view of the benefits of employing rigid or semi-rigid rotors, and/or using carbon fiber composites or other composite structural materials having elasticity modulus of at least 40 msi to reduce whirl flutter that would otherwise occur with increased wing aspect ratios above 6, FIG. 2 should be interpreted as having the rotors 124M, 134M and/or wing materials in the wings 120M, 130M modified in such manner with respect to FIG. 1.

FIG. 2 also depicts a controller 140 that provides reduced RPM in a forward flight relative to hover. The electronic or other connections of the controller 140 to actuators (not shown) of the blades of the rotors 124M, 134M, and to the rotor motors (not shown) are omitted for simplicity in the drawing. Such connections are conventional, and will be understood by those of ordinary skill in the art that conventional connections can be employed. Controller 140 or a different controller 150, can provide variable speed, (a so-called “Optimum Speed Tilt Rotor”) as set forth in U.S. Pat. No. 6,641,365 to Karem (November 2003).

### Increased Efficiency

Although it may not be apparent to those of ordinary skill in the art, there are major advantages to providing increased wing span and wing aspect ratio. One advantage is the increase in aircraft cruise lift/drag ratio, and the resulting increase in aircraft efficiency and fuel economy. Another major advantage is reduction in the down load that acts on the wing in hover. This reduction in down load is a result of both the narrower wing chord and the smaller area of the wing in the down wash of the rotor. Such reduction in down load provides for either an increase in aircraft vertical take-off weight (resulting increase in payload or fuel carried by the aircraft) or a decrease in the required rotor size, engine power and gearbox torque as compared the standard aircraft with the aspect ratio 5.5 wing.

According to calculations, increasing the wing span and aspect ratio and decreasing the wing chord at the above stated values to achieve a wing aspect ratio of 9.3 provides the following benefits due to improved aerodynamic efficiency:
41% decrease in drag due to lift (induced drag in the aerospace vernacular) in cruise flight in airplane mode, which usually translates to 20% reduction in drag at cruise speed for best economy;
20% reduction in rotor power required for economical cruise at a given rotorcraft weight (longer rotor, engine and gearbox lives).
20% increase in cruise fuel economy.
20% increase in range.
Substantial increase in cruise altitude for better weather avoidance (requires increase in cabin pressurization). While longer and higher aspect ratio wings will often be heavier, the weight increase will be more than compensated for by the higher available hover and VTOL weights, due to more than 23% decrease in hover down load. This reduction in down load is the result of the 23% narrower wing chord (smaller wing area under the rotor in hover and VTOL) and of the reduced flow interference between the two rotors and between the rotors and the fuselage.

Thus, specific embodiments, applications, and methods have been disclosed in which tilt-rotor aircraft have high wing aspect ratios. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A rotorcraft comprising:
a wing supporting a tilting rotor; and
the wing having an aspect ratio greater than 6.

2. The rotorcraft of claim 1, wherein the wing has an aspect ratio greater than 7.

3. The rotorcraft of claim 1, wherein the wing has an aspect ratio greater than 8.

4. The rotorcraft of claim 1, wherein the wing comprises a composite having an elasticity modulus of at least 40 msi.

5. The rotorcraft of claim 1, wherein the wing comprises a carbon epoxy composite.

6. The rotorcraft of claim 1, further comprising a rigid or semi-rigid rotor.

7. The rotorcraft of claim 1, further comprising rotors that are not teetering, gimbaled, or articulated.

8. The rotorcraft of claim 1, further comprising a low inertia rotor.

9. The rotorcraft of claim 1, further comprising a high stiffness blade.

10. The rotorcraft of claim 1, further comprising a controller that provides reduced RPM in a forward flight relative to hover.

11. The rotorcraft of claim 1, further comprising an optimum speed tilt rotor.

12. The rotorcraft of claim 1, further comprising at least three of (a) a wing comprising a composite having an elasticity modulus of at least 40 msi or a carbon epoxy composite; (b) a rigid or semi-rigid rotor; (c) a low inertia rotor; (d) a high stiffness blade; (e) a controller that provides reduced RPM in a forward flight relative to hover; and (f) an optimum speed tilt rotor.

13. The rotorcraft of claim 2, further comprising at least three of (a) a wing comprising a composite having an elasticity modulus of at least 40 msi or a carbon epoxy composite; (b) a rigid or semi-rigid rotor; (c) a low inertia rotor; (d) a high stiffness blade; (e) a controller that provides reduced RPM in a forward flight relative to hover; and (f) an optimum speed tilt rotor.

14. The rotorcraft of claim 3, further comprising at least three of (a) a wing comprising a composite having an elasticity modulus of at least 40 msi or a carbon epoxy composite; (b) a rigid or semi-rigid rotor; (c) a low inertia rotor; (d) a high stiffness blade; (e) a controller that provides reduced RPM in a forward flight relative to hover; and (f) an optimum speed tilt rotor.

15. The rotorcraft of claim 1, further comprising the wing supporting a second rotor.
